(19) United States
(12) Patent Application Publication
(10) Pub. No.: US 2003/0073499 A1
(43) Pub. Date: Apr. 17, 2003

(54) Network gaming device and method for allowing a player to participate in a live game over a network

(76) Inventor: Kenneth Reece, Arroyo Grande, CA (US)

Correspondence Address: Mr. Kenneth Reece, 3689 Alisos Road, Arroyo Grande, CA, 93420, US

(21) Appl. No.: 10/263,565

(22) Filed: Oct. 2, 2002

Related U.S. Application Data
(60) Provisional application No. 60/326,785, filed on Oct. 2, 2001.

(51) Int. Cl. A63F 13/00

(52) U.S. Cl. 463/42

(57) ABSTRACT

A gaming device for use over a network and a method for instantly placing any size bets and receiving winnings in a secure, convenient and optionally anonymous manner are provided. The gaming device comprises means for coupling the gaming device to a game provider's game server over a network. The game server determines the outcome of a game and calculates winnings and transmits the result to the gaming device over the network. The device comprises means for graphically or electro mechanically displaying the result of any particular game, either on the device itself or on a display of a computer coupled to the gaming device. The device can optionally have a replaceable top, whereby it can be adapted to play a plurality of games and said replaceable top comprises a plurality of buttons for allowing a player to control certain parameters of a game. In the preferred embodiment of the invention the device is formed as a desk top slot machine which comprises a manual pull arm for allowing to “spin the reels” in a traditional fashion. Furthermore the device comprises at least one card read/write device, for allowing a player to insert a payment card such as a smart card, into the card read/write device, and have bets transferred from the card before each play. Any winnings are instantly transferred from the game provider to the player's card after a winning game is completed.

### CROSS-REFERENCE TO RELATED APPLICATION

This application is entitled to the benefit of Provisional Patent Application Ser. No. 60/326,785 filed Oct. 2, 2001.

### FEDERALLY SPONSORED RESEARCH

Not Applicable

### SEQUENCE LISTING OR PROGRAM

Not Applicable

### BACKGROUND

### Field of Invention

The present invention relates generally to an electronic data input device for use over a network, specifically to a network gaming device.

### BACKGROUND

### Terminology

Network

In the context of the invention the term “network” is used to describe any network where a plurality of computers or game devices, are linked together, either through at least one server or through a peer-to-peer connection. A few examples of such a network are:

A public network like the Internet

Proprietary networks like AOL and Compuserve

Corporate Intranets

Hotel's internal network

Casino

In the context of the invention the term “casino” is used to describe any game provider.

The Device/The Gaming Device/The Gaming Machine

The terms “the device”, “the gaming device” and “the gaming machine” are used interchangeable to refer to the device of the present invention.

Connection

In the context of the invention the term “connection” is used to describe any means of coupling a plurality of devices, either through a wired connection or through a wireless connection or a wireless link.

Card

In the context of the invention, “card” is used to describe any type of card of the kind incorporating a hybrid or monolithic integrated circuit or “microchip”. The term “microcircuit” will be used hereinafter.

In the context of the invention, the term “card” is used to refer to both contact smart cards and contact less smart cards.

The term “card” is also used to describe a microchip by itself or integrated with other objects, in particular portable objects. Examples of such objects are credit cards, memory cards, SIM cards (like those used in cellular phones), keys or key-rings. The term “card” is further used to describe the microchip integrated with any other object than those mentioned in the example.

In this disclosure, the terms “IC card”, “chip card”, “smart card” and “card” will be used interchangeably to denote cards as explained above.

PC Card

The term “PC Card” is used to describe any computer peripheral device formed as a PC Card or other standards as defined by the PCMCIA. The standards include (but are no limited to) PC Card, CardBay, CardBus, Miniature Card and Smart Media Card. Refer to www.pc-card.com for further information about these standards.

PCB

The term “printed circuit board” or “PCB” is used to describe any type of circuit board with interconnecting conductors, regardless of the method used to manufacture said circuit board.

Casino Game

In the context of the present invention the term “casino game” is used to describe any game or bet that can be played for money or any other value. These games include every game played in any traditional casino, but also sports bets and other bookmaker bets are referred to in the following as a “casino game”.

Remote Player

In the context of the invention, the term “remote player” is used to describe any player that can participate in a game over a network.

Display of the Gaming Device

In the context of the invention the term “display of the gaming device” is used to describe any means for displaying game results to a player. The display can either be comprised directly in the gaming device or it can be attached to the device in a separate top, similar to the display of a portable computer. A monitor attached to a computer, that is used to display gaming results and information is also referred to as the “display of the gaming device” in the following.

Remote Game

In the context of the invention, the term “remote game” is used to describe any game that can be played over a network.

### BACKGROUND

### Introduction to the Relevant Industry

According to a documentary television program about the US gaming industry shown on the Discovery Channel (US) in September 2001, about 70% of the gaming industry's revenues derives from gaming machines such as slot machines, virtual poker or virtual black jack. Of all gaming machines, slot machines are providing the majority of the revenues.

To play one of those game machines provided by a publicly regulated and licensed casino, a player today must be physically present at the machine that is most often placed on the premises of various casinos in different US states and countries around the world.

In many places around the world, and in the US, it is not possible or convenient for players to get to a casino to gamble. This is particularly true for players that live in states or countries that do not have any casinos mostly because of local legislation.

It has previously been illegal for any US corporation or citizen to offer gambling over the Internet. However the legal issues in the US (and internationally) concerning gambling on the Internet are slowly being resolved and in May 2001 Nevada as the first US state passed a bill to allow licensed Nevada casinos to obtain a license to offer gaming over the Internet. Following this important decision, a plurality of demands has arisen:

Demand for Remote Gaming

There is a demand for casinos to provide remote gaming options that will allow players to participate in casino games over a network, such as the Internet.

Demand for Authentic Gaming Experiences

Many players travel to casino destinations like Las Vegas, not only to play a plurality of games for money, but also for the total experience. When providing remote gaming possibilities, there is a demand for casinos to provide as authentic a gaming experience as possible.

Demand for Micro-Payments to Pay for Small Bets

When a player visits a casino, for example in Las Vegas, he/she can walk in from the street anonymously, drop a quarter in a slot machine, and leave with any money the player might have won. It is simple, fast and convenient, and does not require players to:

establish an account with the casino prior to playing

give out any personal information to be allowed to play

give out his credit card information

commit to more than 1 bet at a time, which is often as low as 25 cents or less.

In order for a game provider to make a remote game appealing there is a demand for a game provider to provide a similar convenient game experience to the remote player.

Today it is not possible to use a traditional credit card to place a bet of, for example just 25 cents or less. A bet of such a small size is often referred to as a micro-payment. Some service providers that are offering various services over the Internet have responded to this situation by offering a subscription model where a user pays a fixed fee for limited or unlimited access to the service in question. From a user's point a view, a subscription model is less desirable than a “pay per use” system, because a subscription model does not allow the user to place a single small bet, and “walk away” without leaving any personal or credit card information behind. This is a serious drawback of any subscriber model from a consumer point of view.

Accordingly there is a demand for a game provider to provide a simple, fast and convenient “pay per use” payment method that:

do not require a user to pre-register

do not require the user to give out personal information

do require the user to provide his credit card information

Demand for Instant Reward of a Winning Player

One advantage that a “real” casino (such as those in Las Vegas) have over an Internet casino today is that a player who wins at a casino instantly receives his winnings—in cash and with no questions asked. Most Internet casinos pay out winnings either through a check that is mailed to the player or through a money-transfer at the winner's expense. Both methods are costly and takes a long time, compared to an instant cash reward at a “real” casino. Furthermore a number of Internet Casinos have gone out of business, leaving many players with unpaid winnings, thus worsening the overall odds for a player to actually win money. In order for serious, legally licensed and regulated casino's to distinct themselves from the more dubious operators, there is a great demand to provide an instant gratification of winning players.

Demand for Secure Transactions

Traditional credit cards are very insecure and make the cardholder very vulnerable to a plurality of fraud schemes. As explained previously, requiring the setting up of an account before allowing a player to play, is highly inconvenient for the user and therefore not a desired solution.

Accordingly there is a demand for a game provider to provide a secure method of transferring funds between a player and the game provider, without causing any greater inconvenience than a player would experience at a real casino.

### BACKGROUND

### Description of Prior Related Art

Description of Some Gaming Machines of the Prior Art

The art has utilized numerous gaming machines designed for allowing players to play casino games such as slot machines, keno, poker, black jack and the like.

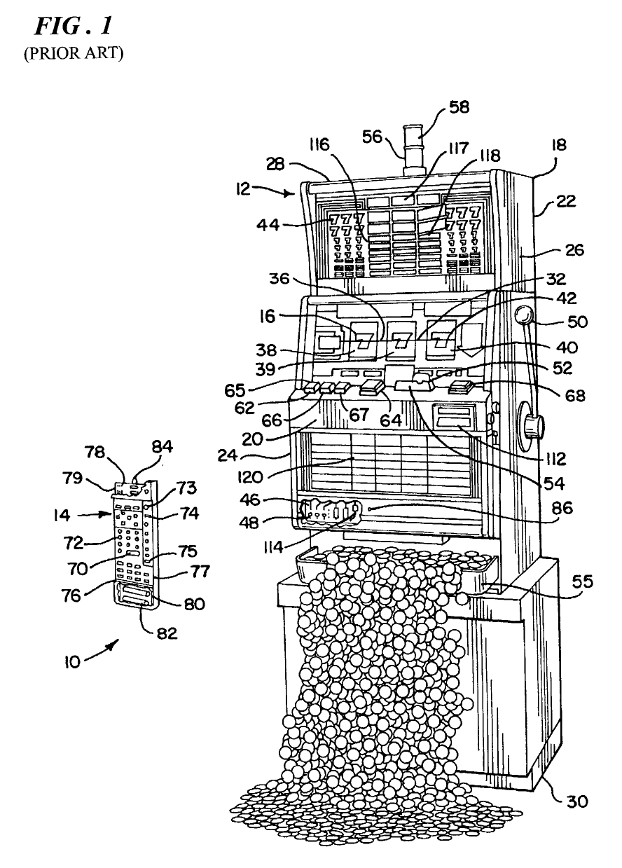

FIG. 1 illustrates an entertainment gaming system 10 that comprises a slot machine 12, such as an improved one arm bandit, and a portable movable remote control 14 which provides a controller that accommodates remote control of the game 16 on the slot machine. Advantageously, the remote control can also simultaneously control two, three or more similar slot machines, if desired to do so by the player.

The slot machine has a slot machine-housing 18 which provides a casing made of metal or impact-resistant plastic. The slot machine-housing has a front 20, back 22, sides 24 and 26, a top 28, and a bottom 30. A transparent display screen 32 comprising a display window made of impact-resistant plastic or glass is provided in the front of the housing to display the game. The display screen can have a single horizontal pay line 36 or a criss-cross pattern of multiple play lines. Preferably, the game comprises at least three reels (wheels) 38-40 or simulated reels. The reels can have indicia 42 comprising symbols, such as: 7's, bells, cherries, stars, bars, plums, oranges, lemons, watermelons, wild symbols, bonus symbols, jack pot multipliers, etc. If desired, the slot machine can comprise a progressive jackpot 44 and the game can comprise a two or three coin multiple game.

Positioned within the interior of slot machine-housing is an electronic device 46, such as a microprocessor, computer chip, or circuit board which contains an electronic control circuit 48 to rotate or simulate the rotation of the reels, as well operate other components and parts of the slot machine as described hereinafter. A mechanical lever 50 comprising a manual pull arm can be provided. The mechanical lever extends laterally outwardly of the housing and can be connected to the electronic circuit and electronic device to spin the reels.

The slot machine also has a coin-input slot 52 with a coin chute 54 in the housing to receive one or more metal coins to activate the game. The slot machine can be programmed to receive one or more desired type of coins, such as, a token, nickel, dime, quarter, half dollar, or other minted coins representing legal tender of the U.S. or foreign governments. A coin-output receptacle 55, which comprises a metal trough, tray, container, or bucket, is located in the lower portion of the housing to receive metal coins upon payout of the game. One or more indicator lights 56 and 58 can extend above the top of housing. Indicator lights are connected to the electronic circuit to signal a visual alarm when the jackpot has been achieved or if the slot machine has been tilted or tampered with or for other situations, as desired.

The slot machine can also have set of buttons 62 which can be positioned below the display screen and above the coin-output receptacle. Desirably, the buttons on the slot machine include at least one play or spin button 64, which is connected to the electronic circuit to spin the reels when the play button is depressed by the player's finger. The button of the slot machine can also include: a change button 65, a cash-out payout button 66, a credit button 67, and a multiple spin button 68 or maximum spin button. The spin button can play the credits chosen by the credits button. The “multiple spin” button is connected to the electronic circuit and can spin the reels automatically for continuous games until the credits are depleted without the need to press the button for each game. The credits can be displayed on the display screen.

For ease of play, the portable hand-held remote control 14 has at least one play or spin button 70 and preferably an array, set or series of manually depressible finger-touch play or spin buttons 72, which emit a signal when depressed (pushed) to the electronic circuit in the slot machine to spin the reels from a remote location spaced comfortably away from the display screen of the slot machine, such as on a comfortable chair or stool. The buttons of the remote control can include: a cash payout button 73, a credit button 74 and a multiple spin button 75. The cash payout button when depressed, can cause coins to be dispensed and discharged coins from the chute into the coin-output receptacle of the slot machine upon winning and payout of the game. The spin button can play the credits chosen by the credits button. The “multiple spin” button is operatively connected to remote control circuit and signals the electronic circuit of the slot machine to spin the reels automatically for continuous games until the credits are depleted without the need to press the button for each game. The credits can be displayed on the display screen. The remote control can further have a card slot 76 to receive a credit card to activate the game. The remote control can also include a plastic insulating remote control housing 77 with an interior containing a remote control circuit 78 on a substrate 79, such as a circuit board or computer chip. At lease part of the circuit in the remote control can be similar to part of the electronic circuit in the slot machine.

In FIG. 1, the portable remote control 14 is energized by one or more batteries 80 and provides a battery-operated hand-held remote control 82. A signaling light 84, such as a light emitting diode (LED), extends from the top of the battery-operated remote control, and is connected to the remote control circuit. When a button is pushed on the remote control visual signals comprising electrical pulses are generated and emitted by the signaling light, which are transmitted to a receptor 86, such as receptor light (lamp) on the front of the slot machine, when the remote control and signaling, light are aimed towards the receptor, to remotely actuate and control the slot machine.

See also the following U.S. Patents, each of which is incorporated herein by reference:

| | |
|---|---|
| Demar et al | 6,270,410 |
| Bennett | 6,089,977 |
| Luciano Jr. et al | 6,267,669 |
| Hedrick et al | 6,135,884 |
| Nolte et al | 6,165,070 |

Disadvantages of the Gaming Machines of the Prior Art

While the above mentioned references each provide one or more solutions to the previously discussed demands, the state of the art does not provide a single device that provide a solution to all of the above discussed demands.

Description of Internet Software Versions of Gaming Machines

Software versions of most casino games are provided by various Internet casino operators. However in regard to present US law all of these Internet casinos are operating illegally with no legal license from any US state. Because these operators are not subject to any form of regulation, there is no protection of the players and numerous examples of fraudulent behavior on the part of several Internet casinos have been reported.

Disadvantages of Internet Software Casino Games

Beside the fact that most, if not all of these games and Internet Casinos today are operated illegally (according to US law regarding US companies and citizens) and non-regulated, a number of other factors make such software games unattractive to intelligent players:

They do not provide any guarantee to players that the games are not fixed

They do not provide any secure method of placing bets and receiving winnings

They do not provide any guarantee that any money a player may win during a session will actually be paid out to the player, should he decide to stop while ahead of the game.

They do not provide the “look and feel” of a real casino experience. One example is the handle on a slot machine which is used to spin the wheels of a slot machine. A majority of slot machine users still prefer to use this handle, even though buttons that offer exactly the same functionality are provided on most modem slot machines. Software games cannot provide this kind of “beloved” features.

Description of Smart Card Payment Systems of the Prior Art

The prior art has utilized a number of payment systems, to allow micro-payments to be made with a smart card. Refer to www.mondex.com for a press release from 1999 describing a smart card transaction that pays for a lottery bet in Norway, and also transfer the winnings back to the card.

Description of Smart Cards

The microcircuit of a smart card is usually based on a microprocessor or a micro-controller including memory circuits, for example of the “PROM” or “EPROM” type. Data can be stored in the aforementioned memory circuits, usually in encrypted form. Some common uses of smart cards includes storing value, storing information for use for identifying purposes, or for access control. The data is read from memory locations and/or written to memory locations.

Other logical architectures are used in particular for “electronic purse” or similar type applications.

To read information from a card or to write information to a card, a device must be provided wherein a card can be inserted for reading and/or writing data to and from the card. For the sake of simplicity, such a device will be referred to as a “reader” or a smart card reader, it being understood that it can equally write data and perform other ancillary functions (such as electrical power supply, tests) referred to hereinafter and in the prior art.

In all cases of contact smart cards, the card incorporates at least one electronic component which comprises input/output members to which a link must be established, either through an electrical connection (in the case of a contact smart cards) or through a wireless connection (in the case of a contact-less smart cards). Said input-output members are often provided in the form of contact areas, also known as “pads”, flush with the surface of one of the principal faces of the card. Various standards (ISO, AFNOR, etc.) define the position of these contact areas. They are used not only for the aforementioned data inputs-outputs but also to supply electrical power to the microcircuit and to enable various checks to be carried out, according to the applications concerned (presence test, etc.).

Contact smart cards traditionally are formed of a plastic plate having about the same thickness as a credit card, with an integrated circuit imbedded in the plastic and with contact pads on a surface of the card. Such cards come in different sizes, with a large size commonly being about the size of a credit card and with a popular small size being referred to as a MICROSIM or simply SIM card. The prior art has provided a plurality of other forms of smart cards, for example where a microchip is embedded in a key or a device to place on a wrist for access control. Another example is a smart card formed as a flexible sheet similar to a piece of paper. The form or shape of the smart card is not important to this invention as it can be adapted to be used with any type of Integrated Circuit card, no matter what form or shape.

Description of Link Between Card and a Computing Device

The contact smart cards are inserted into connectors that make contact between the contact pads of the card and a plurality of contacts comprised in the connector to establish an electrical connection to the electronic components of a printed circuit board (PCB).

The contact less smart cards uses wireless means of communication, such as Radio Frequencies, to couple the smart card and the electronic components of a PCB. A conductive path is provided on a PCB to form an integral antenna, that is used to communicate with the smart card.

Common Uses of Smart Cards

Smart cards are particularly adapted for use in industries requiring strict access or billing control and convenient as well as secure access to sources of payments and information. Such applications include public phones, vending machines, copy machines, laundromat machines, public transportation ticketing and portable devices such as cellular phones, pagers, PDAs, laptop computers and other similar electronic devices and also stationary devices such as a PC, a satellite receiver or a telephone. Such cards can also be used in applications relating to payments, loyalty programs, citizen cards, electronic elections, health services, ticketing, security access and machine controls and many more.

The cards are commonly used to authorize transactions such as purchases of goods, for access control, for identification purposes, and to allow operation of an automobile radio. Use of smart cards for secure identity authentication purposes and for online payment transactions over the Internet are increasing.

Introduction of the Object of a Smart Card Reader

In order to effect electrical connection between a smart card and a PCB, an electrical connector or smart card reader is employed such that the connector securably accommodates the smart card therein. The connector serves as an interface between a smart card and a reading system that interprets the information contained in the card. A few examples of such a reading system are a computer, a satellite receiver, a cell phone, a pay phone, an electronic lock etc.

Introduction of Smart Card Connectors of the Prior Art

The art has utilized numerous electrical connectors specifically designed for use in removably connecting various types of IC cards.

See the following U.S. Patents, each of which is incorporated herein by reference:

| Inventor | U.S. Pat. No. |
|---|---|
| Schuder, et al. | 6,283,376 |
| Wu, et al. | 6,280,254 |
| Yasufuku, et al. | 6,278,610 |
| Bohm | 6,275,383 |
| Nishioka | 6,267,619 |
| Heim, et al. | 6,261,128 |
| Chen | 6,261,113 |
| Neifer | 6,250,965 |
| Heim | 6,244,911 |
| McDowell, et al. | 6,244,902 |
| Beun, et al. | 6,243,273 |
| Reichardt | 6,241,557 |
| Bricaud, et al. | 6,241,545 |
| Ogura, et al. | 6,238,248 |
| Somerville, et al. | 6,234,844 |
| Odic | 6,231,395 |
| Schnell, et al. | 6,231,394 |
| Kaneko | 6,227,893 |
| Simmel, et al. | 6,220,882 |
| Hoolhorst, et al. | 6,210,233 |
| Fukuda | 6,206,732 |
| Chen | 6,206,710 |
| King | 6,200,166 |
| Luvini, et al. | 6,193,557 |
| Lim | 6,179,638 |
| Klatt, et al. | 6,176,724 |
| Sakata, et al. | 6,176,723 |
| Gottardo, et al. | 6,176,721 |
| Martucci | 6,174,188 |
| Yamagami, et al. | 6,174,187 |
| Benjamin, et al. | 6,168,082 |
| Bourne | 6,165,021 |
| Chang | 6,159,051 |
| Bernardet, et al. | 6,159,028 |
| Bricaud, et al. | 6,149,466 |
| Berg, et al. | 6,149,465 |
| Gastineau | 6,149,450 |
| Chang | 6,146,195 |
| Berg, et al. | 6,142,802 |
| Seeley, et al. | 6,132,223 |
| Chang | 6,129,588 |
| Ikemoto | 6,129,571 |
| Kihira, et al. | 6,129,558 |
| Chang | 6,126,486 |
| Lyons | 6,123,456 |
| Bricaud, et al. | 6,120,328 |
| Babineau, et al. | 6,115,263 |
| Hyland | 6,112,994 |
| Wood, et al. | 6,107,122 |
| Michaelis, et al. | 6,106,317 |
| Lotz | 6,105,872 |
| Haffenden, et al. | 6,102,743 |
| Kusakabe, et al. | 6,102,723 |
| Kubo | 6,101,372 |
| Wu | 6,099,353 |
| Hyland, et al. | 6,095,868 |
| Nishioka | 6,089,919 |
| Chang | 6,086,426 |
| Lescoat | 6,086,425 |
| Chang | 6,086,424 |
| Lotz | 6,086,423 |
| Wienand, et al. | 6,079,265 |
| Zuin | 6,068,514 |
| Davis, et al. | 6,062,911 |
| Hyland, et al. | 6,062,889 |
| Schuster, et al. | 6,062,887 |
| Pollock, et al. | 6,056,601 |
| Nishioka | 6,056,573 |
| Bricaud, et al. | 6,053,776 |
| Ungermann, et al. | 6,053,775 |
| Lok | 6,050,857 |
| Helmstetter, et al. | 6,046,913 |
| Benjamin, et al. | 6,039,599 |
| Hyland | 6,024,593 |
| Fuchs, et al. | 6,004,168 |
| Reichardt, et al. | 6,000,969 |
| Chang | 5,997,356 |
| Inadama | 5,997,345 |
| Akama, et al. | 5,997,315 |
| Klatt, et al. | 5,993,261 |
| Iguchi | 5,993,232 |
| Chan, et al. | 5,991,158 |
| Sugimoto | 5,986,891 |
| Berg, et al. | 5,980,324 |
| Bricaud, et al. | 5,980,323 |
| Kanda, et al. | 5,980,294 |
| Ichimura | 5,980,277 |
| Joly | 5,975,959 |
| Korsunsky, et al. | 5,969,330 |
| Vallat | 5,969,329 |
| Wu, et al. | 5,961,338 |
| Ichimura | 5,954,530 |
| Ichimura | 5,951,315 |
| Vallat | 5,945,662 |
| Yu | 5,941,723 |
| Roelofs, et al. | 5,926,365 |
| Sato, et al. | 5,906,516 |
| Nixon | 5,883,786 |
| Bricaud, et al. | 5,882,230 |
| Takemura | 5,850,103 |
| Bricaud, et al. | 5,823,828 |
| Delprete, et al. | 5,820,391 |
| Brioaud, et al. | 5,800,200 |
| Bricaud, et al. | 5,775,949 |
| Hashiguchi | 5,775,929 |
| Kwiat, et al. | 5,746,626 |
| Bricaud, et al. | 5,746,607 |
| Wienand, et al. | 5,744,713 |
| Kaneshige, et al. | 5,743,766 |
| Verstijnen | 5,733,147 |
| Braun, et al. | 5,718,609 |
| Brunker, et al. | 5,713,764 |
| Sakata, et al. | 5,695,353 |
| Takemura | 5,674,080 |
| Broschard, III, et al. | 5,667,408 |
| Broschard, III, et al. | 5,667,397 |
| Broschard, III | 5,653,610 |
| Nishio, et al. | 5,639,265 |
| Kinross | 5,620,342 |
| Broschard, III | 5,599,203 |
| Duke, et al. | 5,595,505 |
| Braun | 5,586,890 |
| Stipanuk, et al. | 5,580,267 |
| Sarradin | 5,574,271 |
| Mizuguchi | 5,567,171 |
| Matsushita, et al. | 5,489,216 |
| Chishima, et al. | 5,474,468 |
| Kessoku, et al. | 5,473,505 |
| Schwan, et al. | 5,470,260 |
| Bellomo, et al. | 5,449,297 |
| Thrush, et al. | 5,425,651 |
| Pickles | 5,423,691 |
| Casses | 5,395,259 |
| Hania, et al. | 5,380,997 |
| Kinross, et al. | 5,366,390 |
| Someno | 5,325,269 |
| Reichardt, et al. | 5,320,552 |
| Imai | 5,316,496 |
| Defrasne | 5,286,957 |
| Dewey, et al. | 5,286,215 |
| Thompson | 5,281,148 |
| Ozouf, et al. | 5,276,317 |
| Reichardt, et al. | 5,269,707 |
| Tseng, et al. | 5,268,820 |
| Schuder, et al. | 5,259,777 |
| Pernet | 5,252,815 |
| Duffet, et al. | 5,224,873 |
| Arai, et al. | 5,211,571 |
| Fuchs | 5,209,669 |
| Anderson, Jr., et al. | 5,205,738 |
| Martin, et al. | 5,198,645 |
| Tanuma, et al. | 5,196,994 |
| Kaneda, et al. | 5,184,282 |
| Pernet | 5,169,345 |
| Licht, et al. | 5,163,854 |
| Birch | 5,161,992 |
| Zaderej, et al. | 5,156,552 |
| Kiat-Hup, et al. | 5,154,644 |
| Ichitsubo | 5,110,309 |
| Mouissie | 5,106,307 |
| Grabbe, et al. | 5,104,324 |
| Takahashi | 5,091,618 |
| Biechler, et al. | 5,052,936 |
| Collier | 5,040,991 |
| Piorunneck, et al. | 5,035,631 |
| Gordon, et al. | 5,013,263 |
| Juret, et al. | 5,013,255 |
| Pernet | 5,012,078 |
| Komatsu | 5,000,694 |
| Buck, et al. | 4,997,376 |
| Billman, et al. | 4,973,270 |
| Yamamoto | 4,968,266 |
| Tkazyik, et al. | 4,941,830 |
| Ichitsubo | 4,932,904 |
| Scholz | 4,932,885 |
| Seidler | 4,932,876 |
| O'Brien | 4,921,453 |
| Anhalt, et al. | 4,919,626 |
| Knight | 4,915,636 |
| Walton, et al. | 4,911,653 |
| Ohkubo, et al. | 4,909,742 |
| Maillot | 4,902,233 |
| Pernet | 4,900,273 |
| Lange, et al. | 4,900,272 |
| Dranchak, et al. | 4,892,487 |
| Andrews Jr. | 4,869,672 |
| Matsuoka | 4,846,713 |
| Shino | 4,843,223 |
| Yasuma, et al. | 4,839,509 |
| Fujii | 4,820,186 |
| Komatsu | 4,810,203 |
| Kniese, et al. | 4,806,103 |
| Owen | 4,795,354 |
| Thrush | 4,781,612 |
| Hamada | 4,780,603 |
| Berg, et al. | 4,780,087 |
| Reichardt, et al. | 4,752,234 |
| Krumme | 4,734,047 |
| Owen | 4,726,775 |
| Mouissie | 4,721,348 |
| Beers | 4,720,156 |
| Sitzler | 4,705,338 |
| Mouissie | 4,701,002 |
| Hvezda, et al. | 4,700,998 |
| Grabbe, et al. | 4,695,111 |
| Massit, et al. | 4,684,181 |
| Dunn, et al. | 4,682,834 |
| Moore | 4,678,252 |
| Stipanuk, et al. | 4,665,614 |
| Furuya | 4,662,702 |
| Kikuchi, et al. | 4,645,277 |
| Krumme | 4,643,500 |
| Sonobe | 4,636,022 |
| Crawford | 4,634,210 |
| Andrews, Jr., et al. | 4,629,270 |
| Boland | 4,598,966 |
| Zrnich | 4,561,711 |
| Olsson | 4,560,221 |
| Noschese | 4,556,268 |
| Lapraik, et al. | 4,553,804 |
| Lapraik, et al. | 4,553,803 |
| Ruehl | 4,553,802 |
| Grabbe, et al. | 4,550,959 |
| Gillett | 4,548,452 |
| Gillett, et al. | 4,542,950 |
| Lumpp | 4,541,678 |
| Steele | 4,540,228 |
| Petit, et al. | 4,469,385 |
| Porter | 4,448,466 |
| Weber | 4,403,819 |
| Endoh, et al. | 4,385,795 |
| Mears | 4,142,226 |
| Sugimoto, et al. | 4,129,351 |
| Andreaggi | 4,113,342 |
| Ostapovitch | 4,070,557 |
| Benasutti | 4,026,627 |
| Vladic | 4,003,625 |
| Sherwood | 3,997,231 |
| BonHomme | 3,517,374 |
| Miller | 3,474,380 |
| Bird | 3,315,217 |
| Tuchel | 3,289,146 |
| Paholek, et al. | 3,234,499 |
| Fedder, et al. | RE32,559 |

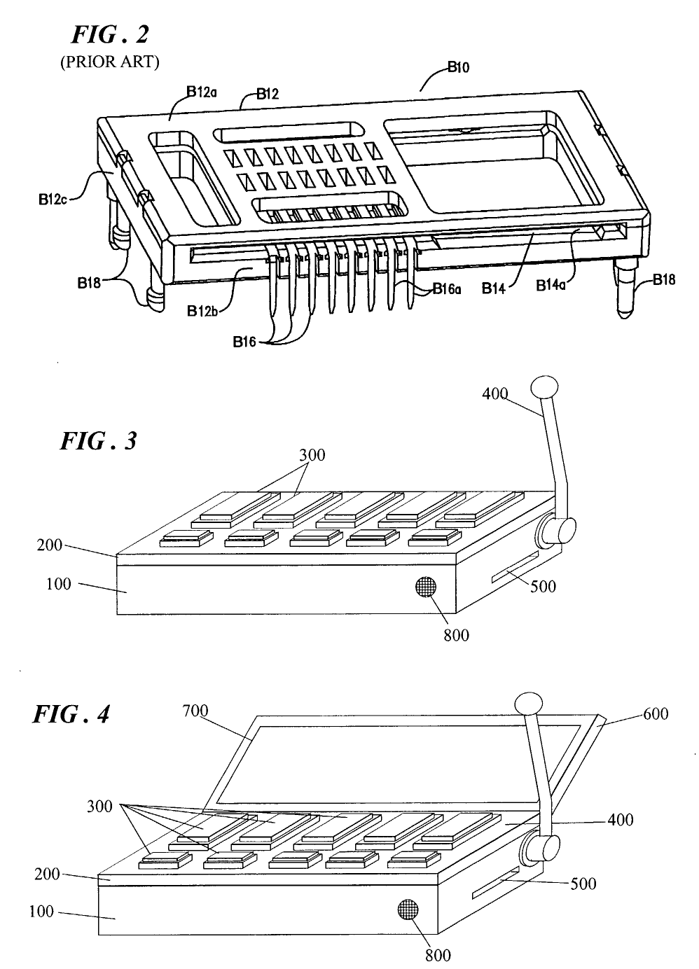

FIG. 2.

An illustrative example of a conventional smart card reader of the prior art is provided in FIG. 2, wherein a smart card connector B10 includes a housing B12 fabricated from an insulative plastic material and having a top portion B12a and a bottom portion B12b having dimensions circumscribed by a peripheral side wall B12c. Top portion B12a and bottom portion B12b together define a linear card insertion slot B14 having ingress B14a through which a smart card enters connector B10. Ingress B14a is generally sized and shaped to correspond to a smart card that is inserted therethrough.

Bottom portion B12b supports a plurality of electrical contacts B16 for electrical engagement with a contact pad of a smart card inserted thereagainst. Contacts B16 lie outwardly from a mid-section of bottom portion B12b and have tail portions B16a that extend normally relative to peripheral wall B12c. Bottom portion B12b further includes one or more securement members B18 protruding from a bottom surface thereof for alignment and securement of connector B10 with a PCB. In order to ensure sufficient termination of contacts B16 to the PCB, bottom portion B12b is positioned flush therewith.

### OBJECTS AND ADVANTAGES OF THE INVENTION

The objects of the present invention is:

A) To provide a gaming machine, such as a slot machine, a video poker machine, a black jack machine or other gaming machines that can be played over a network (such as Internet or AOL), from a remote location such as the home of a user.

B) To provide a secure payment option for bets and winnings of games played over a network.

C) To provide means for instantly transferring bets and winnings between a player and a casino before and after each particular game (or “spin”).

D) To provide means for game providers to offer games in geographical areas where they have no physical presence thereby multiplying by a high factor the potential customer base of a game provider.

E) To provide means for players to play a casino game, without the cost and inconveniences of traveling to the physical location of a game provider.

Advantages

From the description above, a number of advantages of the present invention become evident:

A) A player will no longer be required to travel to a casino to play a game machine

B) A game provider can reach a much larger audience, when there is no requirement for players to be physically present at a casino.

C) A game provider can reach a global market over a network such as the Internet, while still providing a game experience similar to the one a player would get playing a machine at a casino.

D) A player can easily and conveniently place even very small bets, in principle down to 1 cent (or even lower) depending on the choice of game and the betting options provided by the game provider.

E) A player does not need to be required to set up an account with the game provider and transfer funds to this account before playing a game provided by the game provider.

F) A player will have the option not to provide any credit card information which would expose the player to credit card fraud.

### SUMMARY

In accordance with the present invention a desk-top casino gambling machine is provided for use over a network such as the Internet, an intern hotel network (a game provider can provide the device in hotel rooms or at the tables in a restaurant) or over a proprietary network like AOL or Compuserve.

In one embodiment the device comprises means for being coupled to a computer and uses the computers monitor to display gaming information and the computers network connection (such as a modem or a network a network adapter) to connect to a game provider's server.

In another embodiment the device is equipped with a display and means for remotely connecting the device to a network (such as a modem or a network adapter), so that access to a computer is not needed to use the device.

The device has buttons and lights and sounds like the gaming machines in a traditional casino, and a slot machine embodiment has an optional pull arm for the players to pull to activate a spin.

The device is equipped with a smart card read/write device to allow instant transfer of winnings and bets to and from a players card. Optionally the device can be equipped with means for the user to provide regular credit card information or account information, such as for example a magnetic stripe reader.

The game provider can use the display of the device to show advertising and special promotion offers and messages, and the surfaces of the device itself is an excellent advertising medium.

Beyond allowing a user to play traditional “machine” games like slot machines and video poker, the device can be used to allow a user remotely, to participate in an actual live game that is taking place at the casino.

To illustrate this feature, the traditional casino game “Roulette” is used as an example in the following:

As previously described the device has means for displaying information, either using a computer monitor or a display attached directly to the device. By setting up at least one web camera at a roulette table in a casino, the casino can allow the “action” to be transmitted through the network (Internet or proprietary) to connected players.

Using a smart card (or other means of payment) and the gaming device, the player can then make a bet on the live game, transfer his bet from his smart card to the casino and await the result of the game.

The casino's game server keeps track of what numbers have been played by which players.

When the ball drops, the winning number is entered into the game server, that then transfers any winning directly to the winnings players smart cards or credit their account depending on the selected (and provided) payment option.

The number can either be entered into the server by the croupier at the same time as he announces the number to the live players, or a software program can be used that automatically reads the winning number and feeds it to the game server. Most casinos already display winning numbers on a display next to a roulette table.

It should be noted that the above mentioned gaming method for allowing a player to participate in a live casino game over a network, is an independent invention by the same inventor that can also be used without the gaming device of the present invention using a computer with an optional smart card read/write device attached thereto.

The gaming device comes in different forms, depending on what game the player desires.

One embodiment of the invention is a hybrid gaming device that allows a plurality of games to be played using the same device. The buttons can be controlled via software, to have different functions depending on the selected game, or the device can have a set of buttons for each game.

An advanced embodiment includes a changeable top, with each different top representing a different game. A player can then buy 1 gaming device and for example 2 or 3 different tops for the player's favorite games.

### DRAWINGS

### Drawing Figures

FIG. 1

FIG. 1 illustrates a front perspective view of a game machine of the prior art.

FIG. 2

FIG. 2 illustrates a front perspective view of a smart card connector of the prior art.

FIG. 3

FIG. 3 illustrates a front perspective view of the invention in the preferred embodiment, which is a desktop network slot machine.

FIG. 4

FIG. 4 illustrates a front perspective view of the embodiment of FIG. 3 further comprising a display that is comprised in a top attached to the device.

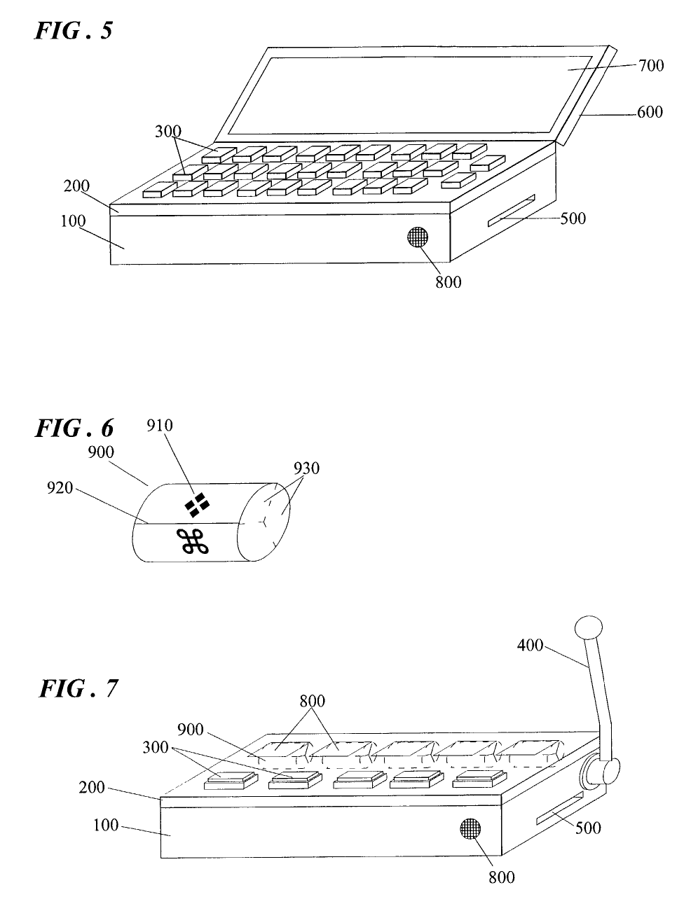

FIG. 5

FIG. 5 illustrates a front perspective view of an alternate embodiment of the present invention.

FIG. 6

FIG. 5 illustrates a front perspective view of a slot machine reel.

FIG. 7

FIG. 7 illustrates a front perspective view of an alternate embodiment of the present invention.

### REFERENCE NUMERALS IN DRAWINGS

FIG. 1 (Prior art)

10 Entertainment gaming system

12 Slot machine

14 Remote control

16 Game

18 Slot machine housing

20 Front of slot machine housing 18

22 Back of slot machine housing 18

24+26 Sides of slot machine housing 18

28 Top of slot machine housing 18

30 Bottom of slot machine housing 18

32 Transparent display screen

36 Horizontal pay line

38+40 Reels (wheels) of slot machine 12

42 Indicia comprising symbols

44 Progressive jackpot

46 Micro processor

48 Electronic control circuit

50 Mechanical lever

52 Coin input slot

54 Coin chute

55 Coin receptable

56+58 Indicator lights

62 Set of buttons

64 Play or spin button

65 Change button

66 Cash-out payout button

67 Credit button

68 Multiple spin button

70 Spin button

72 Finger touch spin button

73 Cash payout button

74 Credit button

75 Multiple spin button

76 Card slot

77 Remote control housing

78 Remote control circuit

79 Substrate

80 Batteries

82 Battery operated hand held remote control

84 Signaling light

86 Receptor

FIG. 2 (Prior art)

B10 Smart card connector

B12 Housing for smart card connector

B12a Top portion of housing 12

B12b Bottom portion of housing 12

B12c Peripheral wall

B14 Card insertion plane

B14a Card insertion ingress

B16 Electrical contacts

B16a Tail portion of electrical contacts 16

B18 Securement members

FIGS. 3-7

100 Body of the device

200 Top of the body of device comprising game buttons

300 Game buttons

400 Pull handle for slot machine games

500 Card insertion slot

600 Top of the device comprising a display

700 Display

710 Transparent “window”

800 Loudspeaker

900 Slot machine reel

910 Indicia

920 Dividing line

930 Sections

### DETAILED DESCRIPTION

FIGS. 1-2

FIGS. 1 and 2 are of the prior art and therefore described in detail under “Introduction of prior art”.

FIG. 3 Preferred embodiment

FIG. 3

The embodiment of the present invention as illustrated in FIG. 3 comprises means for coupling the gaming device to a computer with a display and a network connection. This embodiment is adapted to play a slot machine game over a network (for example the Internet).

After connecting the power, the player selects which game he wants to play and is then directed to a game providers game server that offer the desired game using any commonly known routing software of the prior art. The computer to which the device is coupled can have the corresponding software installed, or the software can be in a processor of the device. The software can also be stored in a smart card that can be inserted into a card insertion slot of the gaming device.

An initial spin is made automatically when a player connects, to give him a starting location for the different (virtual) reels (wheels) of the slot machine.

The player inserts his smart card and use a button on his device to select the amount for each bet (for example 25 cents). Another button is used to control how many bets the player wants to place. The display constantly shows the player's current betting status (amount of each bet, number of bets placed and the total of all bets placed).

Using the game buttons 300 the player decide which wheels to “hold” before spinning the wheels.

When the player presses the “spin” button (or pull the optional handle 400), the total betting amount is instantly transferred from the players inserted stored value card (a smart card) to the game provider through the network connection.

After receiving the payment the game server selects the outcome of the different wheels, and the result is displayed at the display of the gaming device.

When a player wins, the winnings are transferred to his card from the game provider.

The value on the stored value can either be “real” currency such as US dollars, but a game providers proprietary tokens can be used, or even points from different loyalty programs, depending on the arrangements the game provider makes. For example a casino can make a deal with a phone company to allow the stored value on the phone company's phone cards to be used as payment in the gaming device. Another example could be airline miles that could be stored on a card and used as payment. Any kind of electronically stored value can be used such as (for example) loyalty points, electronic coupons, electronic cash, proprietary token systems etc.

The body top 200 is replaceable by a player to allow one gaming device to be used to play a plurality of games using different body tops 200. A body top 200 can also be adapted to be used to play a plurality of games, without the need to replace said body top.

A loudspeaker 800 are used to play sounds that are normally associated with gaming machines, such as coins falling down to a tray when a pay out is made etc.

The pull handle 400 is an optional feature players (or game providers) can attach to the device with the “look and feel” of a real slot machine. An identical functionality can be obtained using a game button 300.

FIGS. 4-7 Alternate embodiments

FIG. 4

FIG. 4 illustrates another embodiment of the invention similar to the embodiment of FIG. 3, but with the device comprising a display and means for connecting said device to a network (for example a modem).

The top 600 comprising the display 700 have means to fold down on top of the body of the device 100, in the same way a portable computer has a top display portion that can be opened and closed.

FIG. 5

FIG. 5 illustrates an embodiment of the invention with a top adapted for playing a roulette game. Each button represents a number on a roulette table, and said buttons can be used by the player to place bets. Also by comprising means of creating different light effects within said buttons, said buttons can be used to illustrate which numbers are played by illuminating the button when it is pressed. Also the winning number can be illustrated by illuminating the button corresponding to the winning number in a special color.

In an alternate embodiment of FIG. 5 a small display (for example an LCD) can be comprised within each button. Said display can then be used to display the exact amount of each bet placed in a specific number etc. Having a display comprised in each button, allows for easy adaptability of the device to be used for playing a plurality of different games, without the need for changing the top.

More or less buttons than illustrated can be placed on the roulette body top. For example buttons to place 50/50 bets (such as red/black) or dozen bets (such as 1-12). Also buttons for placing bets “on the line” between more than one number can be provided. These types of bets can also be made possible by configuring the buttons, so that for example 2 adjacent buttons pressed simultaneously place a bet with half the betting amount on each number.

FIG. 6

FIG. 5 illustrates a slot machine reel 900. Each reel is divided by a line 920 into a number of sections 930, each of which having insignia 910.

FIG. 7

FIG. 7 is an alternate embodiment of FIG. 3, which comprises a plurality of slot machine reels 900. The body top 200 comprises a plurality of transparent windows 710 through which the insignia of the slot machine reels 900 can be seen.

### CONCLUSION, RAMIFICATIONS AND SCOPE

### Conclusion

It is evident from the foregoing description that the present invention is useful for various applications wherein a gaming device that allows a player to participate in a casino game over a network, and which provides the player with the option to use the advantages of smart card technology to transfer funds to/from a game provider is desired. The present invention does so without compromising the valuable authentic gaming experience a player would get using a gaming machine in a casino and without requiring a player to travel to a live casino to play a casino game.

By comprising a smart card read/write device into the gaming device, it is made possible for a player to place a micro-payment bet over a network, in a fast, convenient and secure way. Furthermore the use of smart cards allows for instant “cash” payment (via transfer of funds to/from a card) of bets and winnings of a network game.

Additionally by making the top of the device changeable, it can easily be adapted to play a plurality of games, as well as the device can easily be adapted for use in other industries as described in the preceding and/or the following.

Furthermore by integrating with the device light- and sound effects as well as real spinning reels in one particular embodiment, an authentic gaming experience from a remote location are made possible.

By providing a web camera close to a “live” casino game a game provider can make it possible for a remote player to follow and participate in any live casino game.

### Ramifications

A) Reel-type slot machine

To provide maximum authenticity, one slot machine embodiment of the present invention (FIG. 7) comprises a plurality of reels used to visually display the outcome of a game to a player, in a way similar to the way a traditional slot machine displays the result of a game. Since this particular embodiment of the present invention will actually have “spinning wheels” it will provide a very authentic gaming experience from a remote location.

B) More than one card reader

It is possible that some game providers elects to use a smart card to store software applications that control what type a game is played on the device and other information related to the different games that are being offered. It is also possible that a game provide whishes to allow a player to use, for example, a stored value phone card to pay for a bet. One embodiment of the present invention provide a plurality of card readers, which will allow a player to insert both an application smart card and a payment smart card into the device at the same time. A plurality of card readers would also allow a user to transfer data from one card to another, depending on what restrictions, if any, the card provider of a particular card has placed on the card.

Also the device can easily be adapted to comprise more than one card reader having means of establishing communication with a plurality of different card types such as magnetic stripe cards, contact smart cards, contact-less smart cards, smart media cards, PC Cards, bar code cards etc.

C) Power Supply

The device can be powered by any power source. For example:

AC/DC

Batteries

Rechargeable batteries

Solar cells

Through a computer or any other device coupled to the gaming device

Any combination of the above

D) Other games than illustrated

The device can be adapted to play any casino game. A few examples of such games are: Black Jack, roulette, poker, craps, slot machines, baccarat, keno and special video versions of all of the above—and other games.

E) Different payment options

The device can be adapted to facilitate a plurality of different payment methods. For the sake of simplicity only the smart card payment system has been described in great detail in the present Provisional Patent Application. For a more detailed description of other payment options, refer to the prior art.

Stored value card (comprising tokens or electronic “cash”)

Prepaid account with the game provider

Traditional credit card

Smart card credit cards

Internet accounts with companies such as American Express Blue or Pay Pal.

Online accounts with established banks such as Bank of America.

Payment over telephone bills

Payment over hotel bills

F) Display in the buttons

Instead of—or as a supplement to a large display, an LCD or other type of display can be comprised within the individual buttons for nice graphical effects.

G) Display comprised in the body of the gaming device.

Instead of placing a display in a top attached to the gaming device, such a display can also be comprised in the body of the device instead. Also a plurality of displayes can be provided, for example as described in U.S. Pat. No. 6,135,884 (Hedrick et al) which is incorporated herein by reference.

H) Additional and optional features

Buttons to place/cancel bets

Alphanumeric keypad to enter required/desired personal information or a pin code (for example for login and other purposes).

I) Examples of places of use

It is described that the gaming device can be used to play a casino game over a network from a private home. The device can be used in any place, where it is desirable to provide the possibility to remotely play a casino game over a network. A few examples (but by no means limited to) are:

Any hotel room

Restaurants/cafeterias (for example at the table)

Waiting rooms at doctors and dentists etc.

Hospitals

Nursing homes

J) Dimensions

The device can have any desirable size. A few examples are:

A size suitable to fit on a desk top.

Palm sized for easy portability

“Full scale” the same size of a normal casino machine, for example for use in waiting rooms or cafeterias.

K) Other game control features

The device can be equipped with any other means for controlling a game such as, for example, a joystick or a steering wheel.

L) Printer comprised in the device

A printer can be comprised in the device, to print coupons to the players. If, for example a casino provide the device in a hotel room, a printer can be used to print a coupon to a player for example to give him a free drink in the bar within the next half hour. The idea is that the casino wants to give the player an incentive to play the device, and also to keep the player in the casinos own environment. Optionally coupons of this kind can be stored on a smart card.

M) Coupled to other devices

The gaming device can be adapted to be coupled to or having comprised therein other devices. One example of such a device could be a computer mouse, for controlling movement of certain features on the display. Other examples includes an external modem, an external printer, any other computer peripheral device or any other device suitable for being coupled with the gaming device.

N) Comprising computer peripheral devices

Any computer peripheral device can be comprised in the gaming device, for example to save space on a crowded desk, or to add functionality to the gaming device.

One example of such a computer peripheral device is a biometric authentication device, such as a fingerprint reader (for example “Identiguard touch verification system security” from Kingston Technology Company), an Iris scanner, a DNA reader, a head shape identifier etc. The prior art provide further descriptions of the functionality of such computer peripheral devices, as well as detailed instructions as to how to construct such devices. Other computer peripheral devices that can optionally be comprised in the game device include:

a modem

a network adapter

a data storage medium such as a hard disk or other media

a PC-card (or PCMCIA cards)

By comprising means for inserting PCMCIA cards or card following other standards, it is made possible for a player to use the device with a number of existing computer peripheral device. For example Kingston Technology Company manufactures a PCMCIA card fingerprint reader, that could be used by parent to prevent unauthorized use of the device, for example to prevent children for using the device.

a camera/webcamera

A webcamea can for example be used together with head shape recognition software to allow—or prevent certain persons for playing over the network (for example parents who wants to prevent their children to use the gaming device, can register their own head-shape (or fingerprint) and exclude everyone else from using the device.

Also a plurality of any computer peripheral devices can be comprised in the gaming device, as well as any combination of different computer peripheral devices.

O) Stand alone unit

Although the preferred embodiment of the present invention connects to a game server over a network, the device can easily be adapted to function as a stand alone unit with its own micro processor that determines the outcome of a game using a random number generator.

The microprocessor in a slot machine embodiment of the device, can be a Motorola 6800 processor available from Motorola Corporation in Illinois. U.S. Pat. No. 6,270,410 B1 (DeMar et al) which is incorporated in the present PPA by reference explains in greater detail the functionality of the microprocessor.

P) The device used as an electronic data input device

Although the preferred embodiment of the present invention are intended to be used to play a casino game over a network, other embodiments utilizes other uses of the device, both in- and outside of the gaming industry. One such example inside the gaming industry is the use of the device to input gaming results, such as, for example, the outcome a roulette ball spin, into a computer or a game server for statistical or payment controlling purposes. The device could be placed next to a real roulette wheel in a casino, and be connected to a game server. When a number comes out, the croupier (or another casino employee) simply press the corresponding number on the device, to transmit the result of the current spin to the game server. This feature could, for example, be used to allow players to follow over the Internet a roulette game that is physically taking place in a casino, by having the game server transmit over the network any number, that is passed to it using an embodiment of the current invention.

Another example of the device used as an input electronic data input device is a “pit boss” at a roulette table who can use an embodiment of the present invention to easily and conveniently input the winning numbers at a roulette table and have them displayed on one of the displays that casinos traditionally have placed close to every roulette table to allow players to follow the game from a distance.

In yet another embodiment of the present invention the device is formed as a POS (Point Of Sale) terminal that for example can be placed at merchants selling lottery tickets. Using an embodiment of the present invention a user can input hers or his desired lotto numbers by pressing the corresponding numbers on the device. The device comprises means for allowing a user to keep track of what buttons have been pressed, for example by using lights comprised in each button, or by showing the inputted data on a display attached—or connected to the device. Once the user is satisfied with the numbers, an “Enter” key can be pressed to transmit the numbers to the lotto provider. If complete automations is desired, the payment can for example be drawn from the users smart card or regular credit card that would need to be inserted into the card reader of the device. A printer comprised in the device could be used to print receipts or lotto tickets to the user. This embodiment will allow users to input their own lotto numbers, complete the payment transaction end get a receipt all without any interference of a merchant.

This will free up much of a merchant's valuable time, and it will in many cases provide a faster service to lotto players.

A similar POS terminal could be used to allow a user to pay a bill. The input device can be used to enter the payment ID and the amount, and the payment can be instantly drawn from an inserted smart card (or any other type of payment card or stored value card), and a receipt printed.

Another example for use of the device outside the gaming industry is to use the device as an input device at elections and/or polls. For example at a presidential election between 2 candidates the device could be equipped with only 3 buttons, a card insertion slot and a fingerprint reader: One button for voting on Candidate 1 (with his name and/or his picture in illiterate countries), one button for voting on Candidate 2, and a transmit button to confirm the voters selection. The card insertion slot could be used to insert a voter registration smart card which could possibly also be a citizen card containing an encrypted image of the user fingerprint. The fingerprint reader will be used to confirm that the fingerprint image on the smart card matches the fingerprint image of the voter. Using the device in elections, particularly with a smart card and/or biometric authentication system, greatly improves the accuracy of the counted votes, the possibility of a voter making a mistake when voting are greatly reduced and there will be no doubt when counting the votes which candidate each particular voter intended to vote for. It is understood that a US election is more complex than described above and the description above is only meant to be illustrative of the use of the present invention in elections.

### SCOPE

Although the US PTO does not require so, a few claims are included below to precisely establish the minimum scope of the invention. The present invention disclosure is meant to be explanatory only. The full scope of the invention is to be interpreted from the claims of any Regular Patent Application that refers to the present Provisional Patent Application.

While terms such as “above”, “below”, etc. are used to help describe the invention as it is illustrated, it should be understood that the device can be configured in any desired shape or form. For example any game buttons that are placed on top of the body of the device, could conceivably be placed on the side of the body, or even on top of the display in alternate embodiments of the present invention.

In any embodiment of the invention, where the device comprise more than 1 card reader the card readers can optionally be configured differently to allow communication between different types of cards, for example a magnetic strip credit card and a smart card.

In yet another embodiment of the present invention the card read/write device is adapted to electrically couple a conductive RF signal path comprised in the PCB to a contact-less IC card.

Various changes to the foregoing described and shown methods and corresponding structures would now be evident to those skilled in the art. It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the claims of any future Patent Application by the same inventor that refers to the present PPA will be expressed.

I claim:

1. A network gaming device, comprising means for a player to participate in a game from a different physical location than where the game is taking place.

2. A device according to claim 1 wherein said network gaming device comprises game buttons in a configuration corresponding to at least one game type.

3. A device according to claim 1 wherein said network gaming device comprises means for coupling said network gaming device to a server.

4. A device according to claim 3 wherein said gaming device is coupled to said server over a network.

5. A device according to claim 1 further comprising means for said player to place bets and receive winnings from said game.

6. A device according to claim 5 comprising means for charging bets and crediting winnings to a telephone bill.

7. A device according to claim 5 comprising means for charging bets and crediting winnings to a hotel bill.

8. A device according to claim 5 comprising a card read/write device.

9. A device according to claim 8 wherein said card read/write device is a smart card read write device.

10. A device according to claim 8 wherein said card read/write device is a magnetic stripe card read/write device.

11. A device according to claim 5 wherein said means to place bets and receive winnings involve the transfer of funds to and from a stored value card, which, at the time of the game, is inserted into a card read/write device comprised in said gaming device.

12. A device according to claim 1 further comprising at least one computer peripheral device.

13. A device according to claim 12 wherein said computer peripheral device is a biometric authentication device.

14. A device according to claim 13 wherein said biometric authentication device is selected from the group consisting of
a fingerprint reader.
an iris scanner
an eye scanner
a DNA reader
head shape recognizing means

15. A device according to claim 12 wherein said computer peripheral device is a modem.

16. A device according to claim 12 wherein said computer peripheral device is a network adapter.

17. A device according to claim 12 wherein said computer peripheral device is a camera.

18. A device according to claim 17 wherein said camera is a webcam.

19. A device according to claim 12 wherein said computer peripheral device is a USB hub.

20. A device according to claim 1 further comprising means for displaying game results.

21. A method for allowing a player to participate in a live casino game over the internet without said player being present at the table where said casino game is played.

22. A method according to claim 21 wherein live images of the game unfolding is transmitted via a network to at least one player connected to said network.

23. A method according to claim 21 wherein said player can place bets and receive winnings to and from a stored value card.
